(19) United States
(12) Patent Application Publication
(10) Pub. No.: US 2007/0086307 A1
(43) Pub. Date: Apr. 19, 2007

(54) Holographic device

(75) Inventor: Coen Liedenbaum, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/581,643

(22) PCT Filed: Nov. 26, 2004
(86) PCT No.: PCT/IB04/03914

§ 371 Date: Jun. 5, 2006

(30) Foreign Application Priority Data
Dec. 8, 2003 (EP) 03078842.6
Aug. 2, 2004 (EP) 04300504.0

(51) Int. Cl. G11B 7/00

(52) U.S. Cl. 369/103

(57) ABSTRACT

The invention relates to an optical holographic device for recording data bits in a holographic medium (106). The device comprises a light modulator (103) with addressable elements (301), each having an area and at least one optically active sub-area (302) smaller than said area, means for directing a radiation beam towards the light modulator to form an encoded radiation beam so as to record at least first and second data bits (401, 402) in the holographic medium, means (200) for displacing the encoded radiation beam with respect to the holographic medium and means for controlling the displacing means so as to record a third data (403) bit between the first and second data bits.

### FIELD OF THE INVENTION

The present invention relates to an optical holographic device for recording data bits in a holographic medium, to a method for recording data bits and to a computer program for carrying out such a method.

### BACKGROUND OF THE INVENTION

An optical device capable of recording on and reading from a holographic medium is known from H. J. Coufal, D. Psaltis, G. T. Sincerbox (Eds.), ‘Holographic data storage’, Springer series in optical sciences, (2000). FIG. 1 shows such an optical device. This optical device comprises a radiation source 100, a collimator 101, a first beam splitter 102, a spatial light modulator 103, a second beam splitter 104, a lens 105, a first deflector 107, a first telescope 108, a first mirror 109, a half wave plate 110, a second mirror 111, a second deflector 112, a second telescope 113 and a detector 114. The optical device is intended to record in and read data from a holographic medium 106.

During recording of a data page in the holographic medium, half of the radiation beam generated by the radiation source 100 is sent towards the spatial light modulator 103 by means of the first beam splitter 102. This portion of the radiation beam is called the signal beam. Half of the radiation beam generated by the radiation source 100 is deflected towards the telescope 108 by means of the first deflector 107. This portion of the radiation beam is called the reference beam. The signal beam is spatially modulated by means of the spatial light modulator 103. The spatial light modulator 103 comprises addressable elements that can be addressed as transmissive areas and absorbent areas, which corresponds to zero and one data-bits of a data page to be recorded. After the signal beam has passed through the spatial light modulator 103, it carries the signal to be recorded in the holographic medium 106, i.e. the data page to be recorded. The signal beam is then focused on the holographic medium 106 by means of the lens 105.

The reference beam is also focused on the holographic medium 106 by means of the first telescope 108. The data page is thus recorded in the holographic medium 106, in the form of an interference pattern as a result of interference between the signal beam and the reference beam. Once a data page has been recorded in the holographic medium 106, another data page is recorded at a same location of the holographic medium 106. To this end, data corresponding to this data page are sent to the spatial light modulator 103. The first deflector 107 is rotated so that the angle of the reference signal with respect to the holographic medium 106 is modified. The first telescope 108 is used to keep the reference beam at the same position while rotating. An interference pattern is thus recorded with a different pattern at a same location of the holographic medium 106. This is called angle multiplexing. A same location of the holographic medium 106 where a plurality of data pages is recorded is called a book.

Alternatively, the wavelength of the radiation beam may be tuned in order to record different data pages in a same book. This is called wavelength multiplexing. Other kind of multiplexing, such as shift multiplexing, may also be used for recording data pages in the holographic medium 106.

A data page comprises a plurality of data bits. The number of data bits in a data page is equal to the number of addressable elements of the spatial light modulator 103. As a consequence, the number of data bits in a data page, i.e. the data capacity of the holographic medium 106, is limited. Actually, the number of addressable elements of the spatial light modulator 103 is limited, because an increase of this number leads to an increase of the size and cost of the spatial light modulator 103, as well as an increase of the power consumption of the holographic device. Moreover, an increase of the size of the spatial light modulator 103 leads to an increase of the size of the radiation beam used for recording the data bits. However, it is difficult to generate a homogenous radiation beam with a relatively large diameter, and this increases the dimensions of the holographic device as well as the costs of the optics.

### SUMMARY OF THE INVENTION

It is an object of the invention to provide a holographic device that increases the density of data recorded in a holographic medium.

To this end, the invention proposes an optical holographic device for recording data bits in a holographic medium, said device comprising a light modulator with addressable elements, each having an area and at least one optically active sub-area smaller than said area, means for directing a radiation beam towards said light modulator to form an encoded radiation beam so as to record at least first and second data bits in said holographic medium, means for displacing said encoded radiation beam with respect to the holographic medium and means for controlling said displacing means so as to record a third data bit between said first and second data bits.

According to the invention, the number of addressable elements in the light modulator is inferior to the number of data bits of a data page. In order to record a data page, a first partial data page is recorded, comprising only a part of the data bits of the data page. To this end, this partial data page is sent to the light modulator and the radiation beam is encoded with these data. Once the first partial data page has been recorded, a second partial data page is sent to the light modulator. The radiation beam is encoded with these data, and the encoded radiation beam is displaced in such a way that the data bits of the second partial data page are recorded between the data bits of the first partial data page. This is repeated until the whole data page is recorded.

This is possible because the addressable elements of the light modulator have an area and at least one optically active sub-area smaller than said area. This means that when two adjacent data bits are recorded in the holographic medium by means of this light modulator, there is place between these two data bits, where a third data bit can further be recorded. As a consequence, the density of the data in the holographic medium is increased without increasing the size, pixel count and cost of the light modulator.

Advantageously, an active sub-area is at least two times smaller than the area of an addressable element. In this case, at least one data bit bay be recorded between two pre-recorded data bits. This means that the data density can be increased at least by a factor 2.

Advantageously, the displacement means comprise an electrowetting based deflection device or a liquid crystal based deflection device. Such a device can displace a radiation beam by application of a voltage between electrodes. As a consequence, no mechanical means are required for displacing the encoded radiation beam with respect to the holographic medium, which reduces the size and the power consumption of the holographic device.

The invention also relates to a method for recording data bits in a holographic medium, said method comprising a step of recording at least first and second data bits by means of an encoded radiation beam, and a step of displacing the encoded radiation beam so as to record a third data bit between said first and second data bits.

Advantageously, the first data bit has a size in a direction and the encoded radiation beam is displaced in said direction over a distance that is smaller than said size. In other words, the first data bit and the third data bit that is recorded between the first and the second data bit overlap. This allows recording the data in the holographic medium by means of run-length limited codes, thus increasing the quantity of information that can be recorded in a same holographic medium.

The invention further relates to a computer program comprising a set of instructions which, when loaded into a processor or a computer, causes the processor or the computer to carry out this method.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1 shows a holographic device in accordance with the prior art;

FIGS. 2a and 2b show a holographic device in accordance with the invention;

FIG. 3 shows a light modulator in accordance with the invention;

FIGS. 4a to 4c illustrate the method in accordance with the invention;

FIG. 5 illustrate the method in accordance with an advantageous embodiment of the invention.

### DETAILED DESCRIPTION OF THE INVENTION

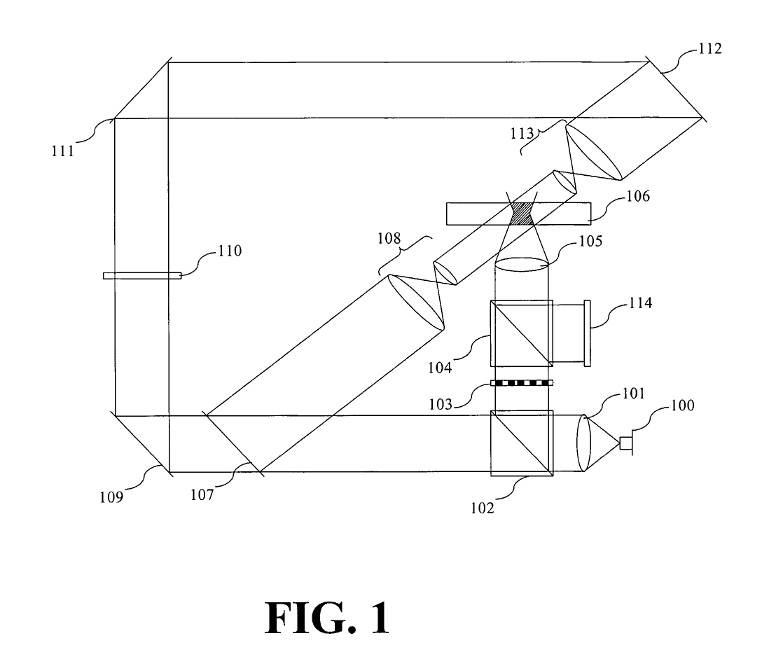

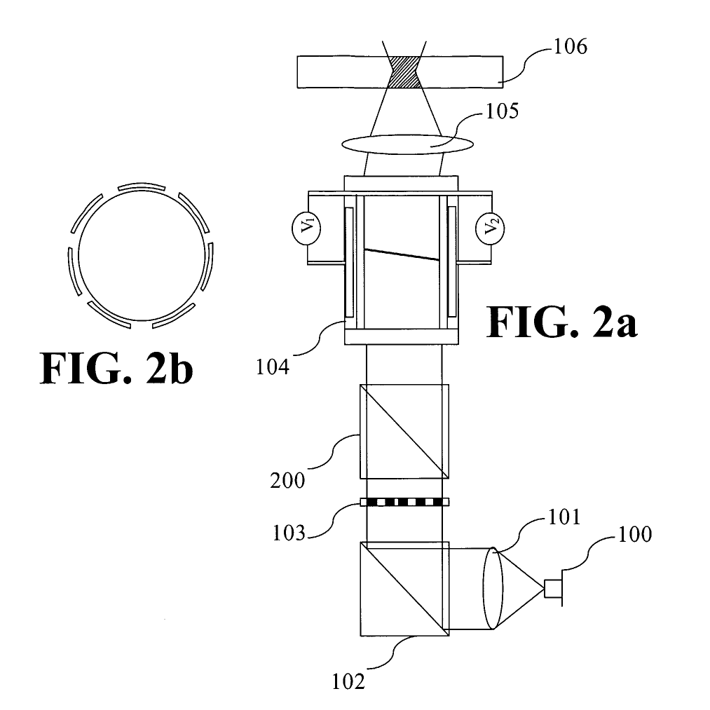

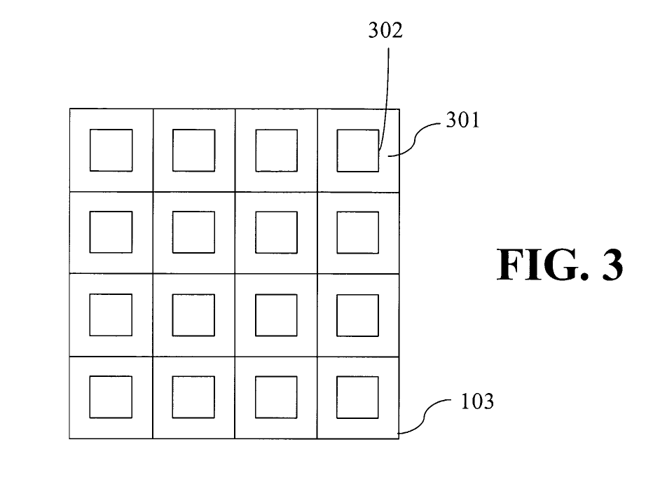

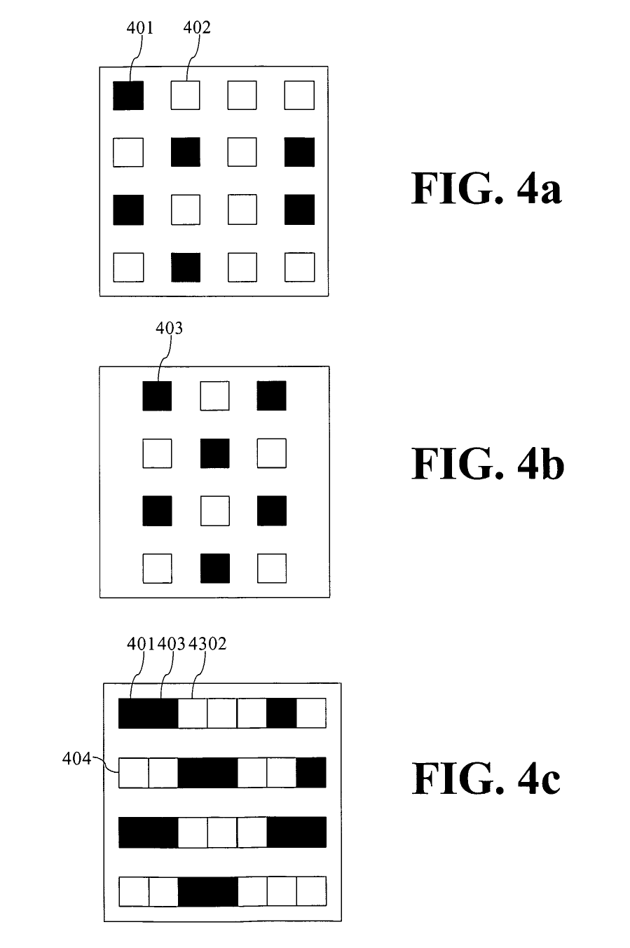

FIGS. 2a and 2b show a holographic device in accordance with the invention. In FIG. 2a, only the signal beam branch as been represented, the reference beam branch being similar to the reference beam branch of FIG. 1. The holographic device comprises the radiation source 100, the collimator 101, the first beam splitter 102, the spatial light modulator 103, the second beam splitter 104, and the lens 105. It further comprises displacing means 200, which role is precised in FIGS. 3 and 4.

In the example of FIGS. 2a and 2b, the displacing means 200 are an clectrowetting device. The displacing means 200 are placed after the spatial light modulator 103, so as to displace the encoded radiation beam with respect to the holographic medium 106. An electrowetting device comprises a fluid chamber and two different fluids separated by a meniscus of which an edge is constrained by the fluid chamber.

The electrowetting device 200 is a segmented electrowetting device. FIG. 2b is a cross sectional view of the segmented electrowetting device 200. The segmented electrowetting device 200 comprises a plurality of electrodes. Different voltages may be applied between a given electrode and a common electrode, such as V₁ and V₂ as represented in FIG. 2a. The segmented electrowetting device 200 thus comprises voltage control means for providing a different voltage to a first electrowetting electrode arranged to act on a first side of the edge and to a second electrowetting electrode arranged to act separately on a second side of the edge. Such a segmented electrowetting device 200 is known from patent application WO2004/051323. As explained in this publication, application of different voltages to the first and second electrodes leads to an angular deflection of the radiation beam passing through the segmented electrowetting device 200. It is thus possible to translate the encoded radiation beam with respect to the holographic medium 106 by application of suitable voltages.

Another example of electro-optical device that can be used for displacing the encoded radiation beam with respect to the holographic medium is a liquid crystal based wedge device such as described in patent application U.S. Pat. No. 5,615,029.

Use of such an electro-optical device as displacing means avoids use of mechanical means, which reduces the size, cost and power consumption of the holographic device. However, mechanical means may be used for displacing the encoded radiation beam with respect to the holographic medium 106. For example, the holographic medium 106 may be mounted on a sledge and displaced. Alternatively, the encoded radiation beam can be displaced by rotation or translation of the spatial light modulator 103 or of the lens 105. Important is that the displacing means are able of displacing the encoded radiation beam with respect to the holographic medium 106, whatever the actual means used for achieving such a displacement.

The holographic device further comprises means for controlling the displacing means. These controlling means are not shown on FIG. 2a. In this example, the controlling means correspond to the voltage control means for controlling the voltages applied to the electrodes of the electrowetting device 200. The control means may comprise a microprocessor that is suitably programmed so as to carry out the method as described hereinafter.

FIG. 3 shows in detail the light modulator 103 of FIG. 2. The light modulator comprises addressable elements, such as addressable element 301. Each addressable element has an area and a sub-area, such as sub-area 302. The sub-area 302 is optically active, whereas the rest of the addressable element 301 is not optically active. In the following example, the sub-area 302 can be made absorbent or transmissive, whereas the rest of the addressable element 301 is absorbent.

Although the light modulator of FIG. 3 only comprises 16 addressable elements, it may comprise much more addressable elements, such as 1000*1000 elements. Each addressable element can be addressed individually, i.e. each sub-area can be made absorbent or transmissive. When the radiation beam passes through an absorbent sub-area, it is blocked, whereas it is transmitted when it passes through a transmissive area.

FIGS. 4a to 4c schematically illustrate the recording method in accordance with the invention. FIG. 4a shows the holographic medium after the first step of the method. During the first step, a first partial data page is recorded. To this end, this first partial data page is sent to the light modulator 103, the radiation beam is encoded with these data and the encoded beam is recorded in the holographic medium as a result of interference with the reference beam. The first partial data page comprises at least two data bits, such as bits 401 and 402.

After the first step, a second partial data page may be sent to the light modulator 103 and the radiation beam is encoded with this second data page. However, this is not mandatory, and the light modulator may remain unchanged. This depends on the way the data to be recorded are encoded. An encoded radiation beam is obtained, which can be the same encoded beam as in the first step, or another encoded beam. In this application, the expression “encoded beam” thus refers to a radiation beam that has been encoded, irrespective of the data it contains.

The second step consists in displacing the encoded radiation beam with respect to the holographic medium 106, and recording the encoded beam in this holographic medium 106. The encoded beam is displaced in such a way that during this second step, a data bit is recorded between two data bits recorded during the first step. For example, the third data bit 403 is recorded between the first and second data bits 401 and 402. The resulting holographic medium is shown in FIG. 4c. FIG. 4b shows the data bits recorded during the second step. In FIG. 4b, the data bits already recorded during the first step have deliberately been omitted.

In the example of FIGS. 4a to 4c, 28 data bits have been recorded in the holographic medium 106 by means of a light modulator 103 comprising only 16 addressable elements. This is more than in the prior art, where only 16 data bits can be recorded. When the number of addressable elements becomes higher, it can be shown that the data density is doubled by application of the method as described in FIGS. 4a to 4c. Moreover, it is possible to ever increase the data density, by displacement of the encoded radiation beam in another direction. For example, a data bit can be recorded between the first data bit 401 and a fourth data bit 404, if the encoded radiation beam is displaced in a direction perpendicular to the direction of displacement in the second step. It can thus be shown that the data density may be increased by a factor 4 in this case.

The increase in data density depends on the ratio between the area of an addressable element and the optically active sub-area. If this ratio is X, it can easily be shown that the data density may be increased by at least X. Preferably, the active sub-area is at least two times smaller than the area of an addressable element. In this case, the data density can be increased by at least a factor 2.

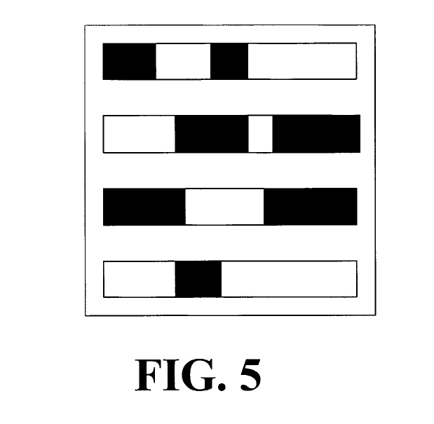

In FIG. 5, a more advantageous embodiment of the method in accordance with the invention is illustrated. FIG. 5 shows a holographic medium recorded by means of this advantageous method. As can be seen from FIG. 5, the holographic medium comprises patterns having various sizes which may differ from a multiple of the size of an individual data bit. This result is obtained in that the encoded radiation beam is displaced over a distance that is inferior to the size of an individual data bit. As a consequence, data bits recorded during two consecutive steps of the method overlap. For example, if the encoded radiation beam is displaced over a distance that is a fraction of the size of an individual data bit, it is possible to record a pattern which size is the sum of the size of an individual data bit and x times this fraction of the size of an individual data bit, where x is an integer.

As a consequence, use of this advantageous method allows encoding the information to be recorded in the holographic medium 106 by means of run-length limited codes. Run-length limited codes are well-known in conventional optical storage such as CD and DVD, but are not yet used in holography, because only patterns which size is a multiple of an individual data bit can be recorded in the prior art. Use of run-length limited codes allows increasing the quantity of information that can be recorded in the holographic medium.

The method for recording data bits according to the invention can be implemented in an integrated circuit, which is intended to be integrated in an holographic device. A set of instructions that is loaded into a program memory causes the integrated circuit to carry out the method for recording the data bits. The set of instructions may be stored on a data carrier such as, for example, a disk. The set of instructions can be read from the data carrier so as to load it into the program memory of the integrated circuit, which will then fulfil its role.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical holographic device for recording data bits in a holographic medium (106), said device comprising a light modulator (103) with addressable elements (301), each having an area and at least one optically active sub-area (302) smaller than said area, means for directing a radiation beam towards said light modulator to form an encoded radiation beam so as to record at least first and second data bits (401, 402) in said holographic medium, means (200) for displacing said encoded radiation beam with respect to the holographic medium and means for controlling said displacing means so as to record a third data bit (403) between said first and second data bits.

2. An optical holographic device as claimed in claim 1, wherein said active sub-area is at least two times smaller than said area.

3. An optical holographic device as claimed in claim 1, wherein said displacing means comprise an electrowetting based deflection device or a liquid crystal based deflection device.

4. A method for recording data bits in a holographic medium, said method comprising a step of recording at least first and second data bits by means of an encoded radiation beam, and a step of displacing the encoded radiation beam so as to record a third data bit between said first and second data bits.

5. A method for recording data bits as claimed in claim 4, wherein said first data bit has a size in a direction and the encoded radiation beam is displaced in said direction over a distance that is smaller than said size.

6. A computer program comprising a set of instructions which, when loaded into a processor or a computer, causes the processor or the computer to carry out the method as claimed in claim 4.
